(19) United States
(12) Patent Application Publication
(10) Pub. No.: US 2001/0032137 A1
(43) Pub. Date: Oct. 18, 2001

(54) Information distribution and redemption system

(75) Inventors: Mark Bennett, Pem-broke, MI (US); Jayson Pankin, Grosse Point Park, MI (US); Andrew Frazier, Oak Park, MI (US)

Correspondence Address: Michael B. Stewart, Rader, Fishman & Grauer PLLC, 39533 Woodward Avenue, Suite 140, Bloomfield Hills, MI, 48304, US

(73) Assignee: Shopsforme.com

(21) Appl. No.: 09/835,206

(22) Filed: Apr. 13, 2001

Related U.S. Application Data
(60) Provisional application No. 60/197,430, filed on Apr. 14, 2000.

(51) Int. Cl. G06F 17/60

(52) U.S. Cl. 705/14

(57) ABSTRACT

An information and redemption system that actively uses targeted and highly personalized e-mail messages to develop and strengthen the affinity between a merchant and the merchant's patrons and potential patrons. Unlike other computer-based marketing systems which passively wait for patrons to visit a web site, the present invention uses an active “push” approach to allow merchants to affirmatively approach those patrons interested in goods, services, or information relating to the merchant. Unlike other direct marketing systems, only patrons who “opt in” to the system participate, and all patrons are free to “opt out” any time. The present invention relies on providing patrons value with each e-mail such that the relationship between merchant and patron is strengthened. The present invention anticipates that the existence of information clearinghouses that can be separate and distinct from merchants. Such clearinghouses facilitate information sharing between merchants that will be mutually beneficial to both the merchants and to the targeted patron.

### RELATED APPLICATIONS

This application claims the benefit of U.S. Provisional Application Ser. No. 60/197,430 filed on Apr. 14, 2000, the contents of which are hereby incorporated by reference in their entirety.

### BACKGROUND OF THE INVENTION

The present invention relates in general to computer-based systems that use the Internet to market goods, services, and information. In particular, the present invention relates to an information distribution and redemption system which utilizes electronic mail (“e-mail”) to develop and strengthen the affinities between a merchant and its patrons.

Merchants are engaged in a constant struggle to compete for the attention and affinity of patrons. As the number of different marketing avenues grows, the competition between merchants to engage in meaningful communication with patrons becomes increasingly intense. Merchants are looking for a way to enable their particular message to penetrate the “noise” and reach the hearts and minds of current and future patrons. The prior art does not provide a cost effective way to actively build more targeted, personalized, ongoing, and mutual relationships with customers.

Direct mail marketing efforts cost somewhere between approximately $0.75 to up to $2 per person. Direct mail does allow a merchant to target individual homes, and thus permits a merchant to pursue a subset of potential patrons. However, the response rate to direct mailing efforts is extremely low, typically on the order of between 1% -2%. The hassles with responding to direct mail apparently make it unattractive for patrons, and ineffective for merchants. The high cost to merchants, especially in light of the low response rates, makes it an inefficient option. Bulk coupons are no better than direct mail in terms of response rates, with less than approximately 2% of recipients responding. It would be desirable to use a less expensive approach with a higher recipient response rate that would also facilitate an iterative flow of communications with the patron.

Advertising through newspaper, radio and television ads is extremely expensive and the effectiveness of such communications is difficult to measure. These marketing forms are also not easily target particular subsets of patrons. Newspaper, radio, and television ads fail to facilitate an iterative communication approach by which the patron or potential patron can provide feedback to the merchant. It would be desirable to provide targeted and personalized information to the patron, while at the same time facilitating a communication loop where the patron is providing feedback to the merchant through actions as well as words.

Even relatively new technologies have substantial weaknesses as information and redemption systems. The use of unsolicited bulk e-mail (“spam”) has generated substantial public hostility to such marketing efforts. The federal government and a number of states are considering e-mail control legislation that would require an “opt-in” feature and extra privacy protections. The Federal Trade Commission is already involved in the consumer protection and privacy aspects of spam marketing practices. Moreover, the response rates to spam are lower than any other marketing avenues, and the approach is not prone to developing a valuable affinity relationship between a merchant and patrons. It would be desirable to use a more personalized and targeted e-mail approach where a true affinity could be developed between a merchant and its patrons.

Internet web sites are another common prior art form to convey and redeem information in a marketing context. A web site is potentially more interactive than a coupon, brochure, or newspaper ad. Moreover, merchants can promote the web sites of other merchants whom the merchant thinks would be of interest to his or her patrons. It would be desirable for a third party to be empowered to maximize the cross-fertilization of information between merchants so that merchants could avoid disclosing confidential and proprietary to each other. It would also be desirable to use the type of information displayed on a web site in a more active way. Web sites are unfortunately a passive information distribution tool in the sense that if a patron or potential patron does not choose to visit a merchant's web site, then that patron will not receive the merchant's information.

### SUMMARY OF THE INVENTION

The present invention relates to an information and redemption system used to develop and strengthen the affinity between a merchant and its patrons. The inventive system allows a merchant to establish and continuously develop lists of actual and potential patrons interested in receiving merchant-specific information or promotional offers through e-mail. Use of the system helps facilitate a merchant's relationship with patrons and potential patrons through the sharing of information or promotional offers that have value to that patron or potential patron. A patron's participation in the system is based on the patron's decision to “opt-in” and a patron may “opt-out” at any time.

The present invention offers an important advantage over prior art systems by allowing merchants to target their message to an interested subset of the merchant's patrons. A pet store could send an e-mail regarding cat food to cat owners and a different e-mail regarding dog food to dog owners. The one size fits all approach under the prior art is a substantial limitation on effective communication and marketing. For example, an elementary school could send a message targeted to parents of third grade children regarding the third grade field trip while the e-mail to parents of sixth grade children could focus on the sixth grade play. A dentist could use the present invention to remind a patient that it was time for a teeth cleaning, and provide a coupon for doing so. A physician could keep his cancer patients informed of new developments in cancer research. A manufacturer could provide an e-mail coupon to consumers who purchased an older version of the product in the past. A book publisher could inform readers of a new release by their favorite author. A landlord could use the present invention to keep tenants informed of maintenance activities and their covenant obligations.

For the purposes of the present invention, a “merchant” includes but is not limited to professionals such as doctors, lawyers, and accountants; businesses such as manufacturers and retailers; non-profit entities; and any other endeavor where an entity wants to develop affinities with its patrons. A “patron” could be a customer, patient, client, parent, student, citizen, or employee, or any other person interacting with a merchant. Similarly, a “store” includes, physician practices, the offices of other professionals, retail stores, restaurants, movie theaters, apartment complexes, or any other location in which a merchant carries out its function or interacts with a patron.

The present invention provides for two-way permission-based communication between a merchant and its patrons. Such communications foster the development and growth of an affinity relationship between a merchant and its participating patrons. Substantial flexibility is facilitated by the invention with respect to the types of communications between the merchant and its patrons, and with respect to the “face” put forward by the merchant to the patron. For example, e-mail clubs could be created to market international brand names at the level of a local store, using a local affinity conduit. Moreover, unlike the prior art systems which utilize one-way disconnected marketing messages, the present invention supports an ongoing real-time two-way form of communication between a merchant and its patrons. The communications sent to the patron depend on the actions and responsive communications of the patron. For example, the present invention could send an e-mail to a grocery store patron to thank him or her for purchasing a new form of ice cream, and include a coupon for whip cream and hot fudge on the patron's next trip to the store. Two-way communications could result in an individual branding experience for each patron and potential patron. Strengthening of the relationship between merchant and patron should serve to increase patron referrals for that particular merchant.

Under the present invention, an information clearinghouse is utilized by the merchant to maintain patron lists and other account related information in a comprehensive database. The clearinghouse may also send either a physical or virtual identification device to the patron to be used by the patron at the merchant's store in order to take advantage of the information or the promotional offer associated with either the e-mail or the identification device. The identification device can be used to communicate information about a patron's activities with respect to a particular merchant, to the clearinghouse. A patron's identification device could work in tandem with a merchant's information storage unit or sometimes known as an instant sign up unit (“ISU”) to maximize the patron-related information obtained and stored for the merchant.

The existence of a clearinghouse entity acting as a facilitator for various merchants can also serve to facilitate cooperation between merchants with respect to their own pools of patrons and potential patrons. A clearinghouse entity can control the exchange of confidential information between merchants so that merchants do not come into contact with information proprietary to another merchant. An information clearinghouse can also facilitate the use of both physical and virtual identification devices for patrons. Moreover, a merchant-based identification card is generally only usable at the store of that particular merchant. A discount card for a particular grocery store chain is an example of such a card. However, a clearinghouse-based identification card may be used at a variety of different stores for a variety of different merchants. Frequent flyer numbers for airlines are an example of a multiple-merchant identification system, with select hotels, airlines, restaurants, rental cars and credit cards all utilizing the same account information across several different markets and merchants. In the example of a frequent flyer number, the airline serves as both a merchant in the airline industry as well as an information clearinghouse for merchants in the hotel, restaurant, car rental, credit card, and other related industries.

A patron's involvement with the present invention begins at the time that the patron signs up to participate in an e-mail club or marketing program. A customized instant sign up unit can be provided at a display unit at each merchant location. The signup process can be a very simply process, requiring only that the potential patron fill out an enrollment card with their name and an e-mail address. The self-addressed enrollment card, which may be postage-paid can then be mailed by the patron to either the merchant, or more preferably, directly to the clearinghouse on behalf of the merchant.

A welcome e-mail is often sent shortly (e.g., within two (2) days) after the enrollment card is received. Regular (e.g., monthly) e-mails with special offers and relevant timely information will then be sent to the patron on an ongoing basis unless the patron subsequently decides to opt out of the program by terminating their enrollment. All e-mails sent out to the patron should have partially or fully customized “From” and “Subject” fields, which encourage patrons to actually open the e-mails instead of merely deleting them from their in-box. All e-mails should also have personalized greetings, a means for receiving patron comments and referrals, and information targeted to be of value to the particular patron. For example, if a pet food manufacturer knows that a patron purchases dog food, that patron should receive a e-mail targeted to dog owners, not to cat owners.

A patron should also be allowed to input and modify information on their patron profile. Allowing customers to maintain profiles of more personal information such as birthdays and anniversaries helps the merchant to support a more personalized feel to ongoing communications. For example, a patron could be sent promotional gift ideas two weeks before a birthday or anniversary. If the merchant is a manufacturer of pet food, a patron profile could include the type, name, birthday and other related information pertaining to the pet. Patron profiles can be used to generate event-based e-mail in addition to the ongoing periodic e-mail broadcasts.

The present invention utilizes regular tracking reports (e.g., monthly) to measure the effectiveness of the marketing and communication effort. Enrollments, referrals, and profiles are tabulated, and all patron comments are reviewed. The effectiveness of particular marketing activities can be evaluated, and future actions can be taken in response to the perceived effectiveness or ineffectiveness of past activities.

The present invention promotes synergies among merchants with similar type of patrons because the present invention allows an information clearinghouse to facilitate mutually beneficial communications between merchants and patrons. In such a setting, an information clearinghouse can serve as an effective gate keeper with respect to confidential and proprietary patron and merchant relating to a particular merchant. Merchants with significant patron or potential patron overlap may use each other's e-mail messages for marketing purposes. In order not to jeopardize the existing affinity relationship, however, cross-merchant activities should only be done when there is a basis to believe that the other merchant's information would actually be of value to the patron.

Various additional features and advantages of this invention will become apparent to those skilled in the art from the following detailed description of the preferred embodiment, when read in light of the accompanying drawings.

### BRIEF DESCRIPTION OF THE DRAWINGS

FIG. 1 is a flow chart of the interactions between a merchant, a patron, and a clearinghouse.

FIG. 2 is a flow chart of a patron enrollment or entry card as processed upon receipt by the merchant.

FIG. 3 is a sample personalized e-mail welcoming a new customer to an e-mail club.

FIG. 4 is a flow chart of how a merchant initiates the storage of a patron's redemption activity.

FIG. 5 is a flow chart illustrating how patrons may opt-in, opt-out, and otherwise interact with the system, and how the system handles bounced e-mails.

FIG. 6 is a flow chart of how proposed e-mail broadcasts are prepared and the internal review process that takes place before e-mail messages are sent to patrons.

FIG. 7 is a flow chart of how e-mail broadcasts are sent.

FIG. 8 is a flow chart detailing how the system processes “bounce-back” e-mails, or e-mails that are undeliverable because the e-mail address is either incorrect, or has changed.

FIG. 9 is a flow chart of the process of splitting campaign e-mails into different e-mail formats such as AOL, HTML, or ASCII

FIG. 10 is a flow chart disclosing a more detailed view of “bounce-back” processing.

FIG. 11 is a flow chart disclosing how a new account process functions beginning from a merchant's decision to participate with the information clearinghouse through the implementation of an onsite display ISU.

FIG. 12 is a flow chart of the upsell and maintenance process between a merchant and the information clearinghouse's account executive.

FIG. 13 is a flow chart of the campaign design and approval process.

FIG. 14 is a diagram of the IMMS methodology for information clearinghouses to manage their merchant clients.

### DETAILED DESCRIPTION OF THE PREFERRED EMBODIMENT

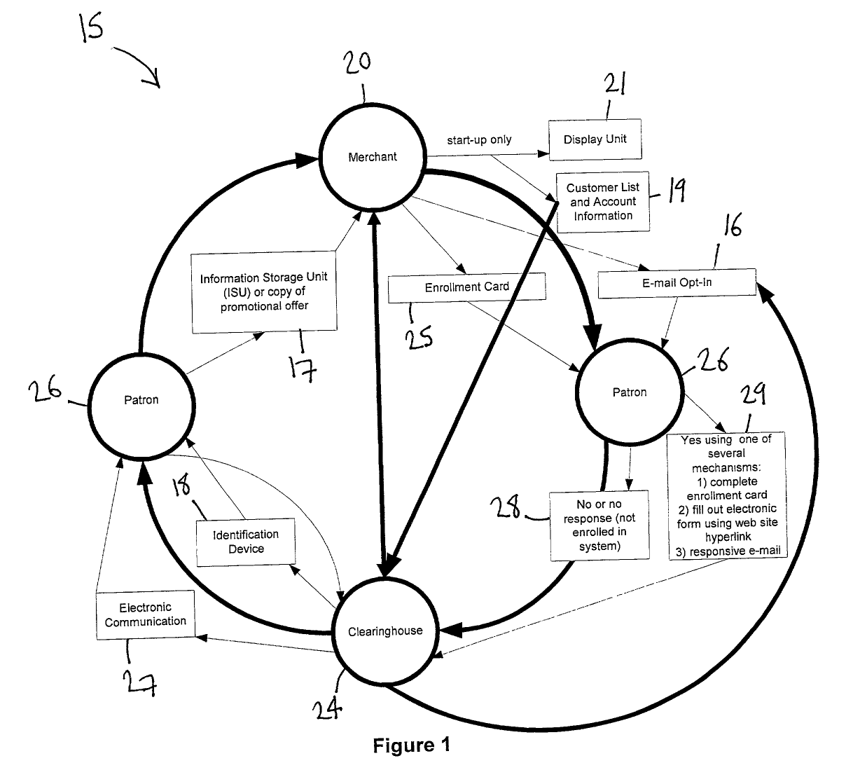

As illustrated in FIG. 1, the present invention relates to an information and redemption system 15 involving a merchant 20, a customer 22, and an information-clearinghouse 24 with an associated database or plurality of databases 23. In its most basic form, the merchant 20 establishes and continuously develops a customer list of actual or potential customer or patrons 26 that have provided an e-mail address and are interested in receiving affinity information or promotional offers relating to specific merchants or brands through e-mail 27. All patron information is stored in database 23 by the clearinghouse 24, and the clearinghouse 24 is responsible for physically sending out all e-mail communications. After an electronic mail (“e-mail”) 27 is received by the patron 26 the e-mail 27 is then printed out or otherwise and presented to the merchant 20 as appropriate.

After a merchant 20 decides to implement the invention, it first sets up a display unit 21 for current and potential patrons 26, virtual display units 21 may exist in the format website displays or the like. The display unit 21 provides a key mechanism through which patrons and potential patrons can first “opt-in” to the inventive system 15. A key feature of the inventive system is to more closely associate patrons 26 and merchants 20 together based on a pre-existing relationship and to reward a specific patron 26 for continuing or further developing that relationship through the sharing of information or promotional offers that have value to that patron. It is essential to the proper operation of the system that the patron 26 opt-in to participate and that both the patron and the merchant 20 receive value through the relationship. The enrollment card 25 which the patron 22 picks up at a physical display unit 21 or fills out using a virtual display unit is a very inexpensive and efficient embodiment of the “opt-in” feature.

A clearinghouse 24 uses pre-existing customer list and account information 19 it receives from each merchant 20 and the patron opt-in information, received through various mechanisms 29 such as 1) a completed enrollment card 25; 2) the filling out of an electronic form (e.g., a hyperlink on a website by either the merchant on behalf of the patron or the patron itself); or 3) a responsible e-mail to create a comprehensive database 23, also discussed in more detail below, which is used in combination with various tools and mechanisms to send personalized e-mail 27 to least a sub-set of the patrons 26 on behalf of the merchant 20. In addition to e-mail 27, the clearinghouse 24 typically sends an identification device 18 to the patron 26 for use when visiting the merchant 20 along with information or a promotional offer contained in the e-mail 27 to encourage use of the identification device 18. Alternatively, the merchant 20 may give the identification device to the patron 26 directly upon receipt of various information required for the patron to use the system. One or more patrons 26 receive the personalized e-mail 27 or identification device 18 and visit the merchant 20 to take advantage of the information or the promotional offer associated with either the e-mail 27 or the information device. Identification device 18 may be physical or electronic, uniquely identifying a patron 26 within system 15.

The merchant 20 receives a confirmation that the patron has visited the patron through one of two mechanisms, identified at point 17. First, if the patron redeems a promotional offer associated with the e-mail 27 the merchant, the merchant has a copy of the e-mail which it forwards to clearinghouse 24. Alternatively, if the merchant has an information storage unit (ISU) at 17 its store location or electronically accessible if associated with a virtual location (e.g., a merchant website) adapted to communicate with a patron's identification device 18, the patron may use its identification device in combination with the ISU to take advantage of the information or promotional offer as discussed in greater detail below.

As noted above, when the clearinghouse 24 first establishes a relationship with a merchant 20, the merchant provides the clearinghouse 24 with a customer list 19 in electronic or paper format that includes customer information comprising least a name and an address (either physical or e-mail). If a physical address is provided, a mailing preferably goes out to the patron with an enrollment card 25 or a return e-mail 16 address to ask if that patron is interested in participating in the system. An advantage of having a physical address is that system 15 is able to determine the physical location of a patron and thus be able to focus further communications within a geographic scope of that address. Typically, zip code information may be used to determine the scope. Other pre-existing geographic information that may be associated with patron 26 includes phone number and license plate information. Yet other information may include credit, social security, or organization membership identification.

If an e-mail address is provided, an electronic mailing 16 alternatively goes out with either an opt out or an opt in option to determine if a patron 26 is interested in participating in system 15. The electronic opt-in or opt-out may simply be the act of responding to the e-mail through a response by responding negatively 28, or by not responding 28. More preferably, however, it involves filling out an electronic form by way of a hyperlink within the communication such that the clicking of the hyperlink takes the patron to a dedicate web page.

The use of a web page opt in is actually preferred, particularly if it is directly associated with the database 23 and if the link includes key information such as a particular merchant, and even a particular location associated with that merchant. Thus, when a patron clicks on the link, the very act of going to a particular web page provides the system 23 with critical information that does not have to be re-keyed by the patron 26. The link may even include the unique identification information (e.g., identification device 18 associated with the patron. If it does, then when the patron 26 clicks on the link and goes to the indicated web page, information already associated with that patron may be populated both from the hyperlink itself and from information contained within the database 23 in association with the patron's identification code to expedite the providing of any correcting or additional information by the patron directly. Thus, third party intervention and complexity, which lead to potential mistakes and undesired costs, are avoided.

Ultimately, whether a patron 26 joins the system using a manual or electronic method, follow up communications may be used to updated or supplement any patron information.

Once at least a name and an e-mail address are established for a particular patron, a unique identification code is also associated for that patron 26. As noted above, that code is propagated by way of identification device 18. A database entry is created for the patron 26 that includes all available information for that patron including the merchant having a relationship with that patron and the physical location of that merchant if it has more than one location. Merchant specific desired information such as birthdays, anniversaries, merchandise preference and the like may also be collected. To avoid later unwanted duplication certain information about any new patron (e.g., e-mail address or mailing address) proposed to be entered into the database is compared with pre-existing entries. If there is a match, to the extent that there is any new information about the patron not already included in the database, that additional information is preferably updated.

A key mechanism for continuously developing a merchant's customer list of patrons 26 who are interested in participating in the system includes in-store display unit 21 including a mechanism for capturing patron information (an “enrollment card”) 25 such as the name and e-mail address, as noted above. A reward is granted to a patron 26 that agrees to participate in system 15. In the preferred embodiment, the reward is typically in the form of a coupon that is sent to the patron by a personalized e-mail 27. The reward is only received and thus able to be used if a correct e-mail address was provided by the patron.

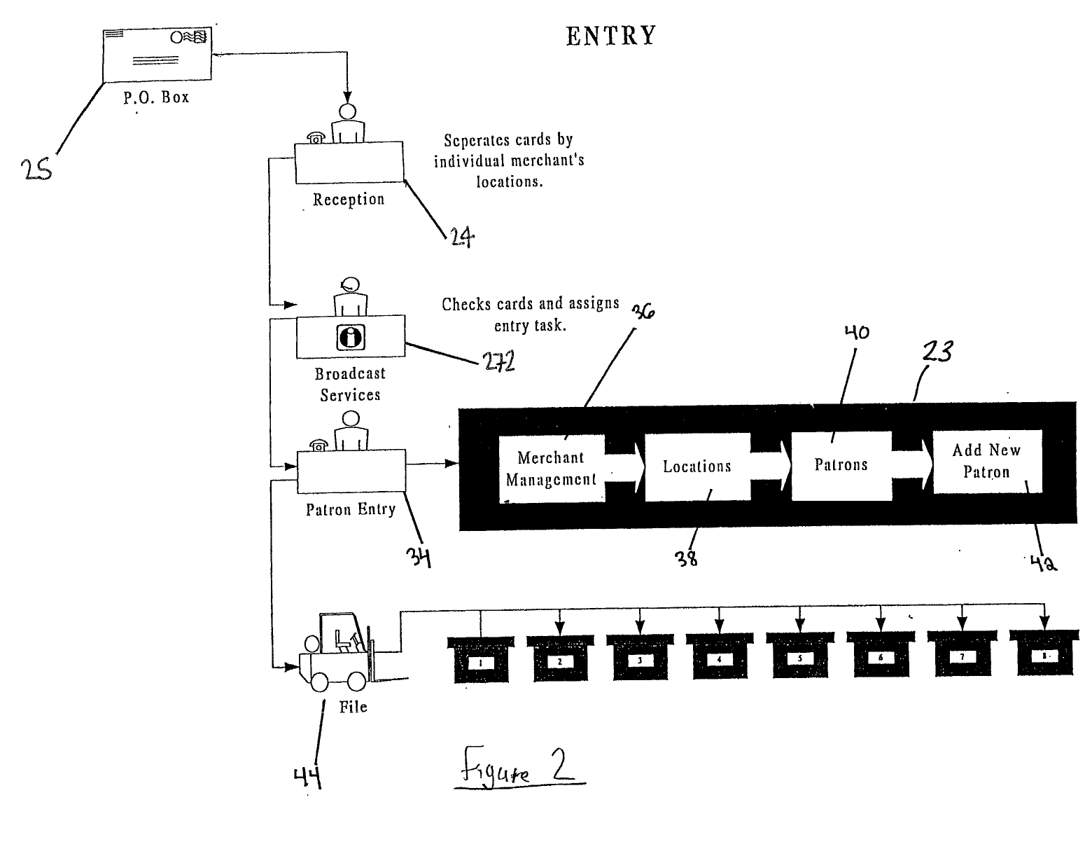

As illustrated in FIG. 2, in a preferred embodiment, the physical mechanism for associating a patron 26 with system 15 using enrollment card 25 typically involves a simple self-addressed postage pre-paid card requesting name and e-mail information along with any other critical patron information deemed important by the merchant 20. The potential value of adding additional data fields to the enrollment card 25 needs to be weighed against the value in minimizing enrollment disincentives to the patron. Only truly critical information fields should be added because keeping the number of required fields low increases the likelihood that a particular patron 28 will take the time to fill it out and mail it in. The enrollment card 25 is mailed to or otherwise provided to the clearinghouse 24, which uses the information to create a new patron entry in the merchant's customer list.

More specifically, enrollment card 25 is received by the information clearinghouse 24 where it is matched with a particular merchant 20 and even a particular merchant location. The card 25 is reviewed at 32 by broadcast services 272, discussed in more detail below. If acceptable, information from the card is entered into the database 23 as shown at point 34. Certain critical information is associated with each card. First, a patron 26 is identified both with a particular merchant 20 at point 36 and then with the physical location 38 of that merchant. If the merchant has numerous locations, not only is it important to know the merchant, but also which store the patron went to. Then the critical information associated with the patron such as the name and e-mail address is added and a record for the patron is created at point 42 with the unique identification code discussed above.

Finally, card 25 is physically stored at point 44 in a box associated with each physical location of a particular merchant 20. In one embodiment, card 25 may be used in a periodic drawing, wherein when a card is drawn; a particular reward is offered to that patron 26 that is not made available to any other patron.

As shown in FIG. 1, it is also possible to participate in the system 15 by sending an e-mail 16 to a predefined e-mail address associated with the clearinghouse 24. In a manner similar to that noted above, a responding message may be sent that includes a hyperlink to a web page to complete a form. Alternatively, a responding message may include the form itself to be completed and returned to the clearinghouse by replying to the message.

It is further possible to participate in the system by going to a pre-defined URL associated with a merchant 20 and using a web opt-in with a registration form that is able to interact with the database 23. The advantage of having the patron 26 provide the necessary information directly without having to re-key the information later is maintained. However, even after the information is keyed through a web site opt-in, any information or promotional offer is still sent by e-mail 27 to confirm the accuracy of the e-mail address for further communications.

Yet a further way to associate a patron 26 with the system 15 is to use a referral system. For example, an existing patron in the system is sent an e-mail communication 27 with information or a promotional offer and is incentified to send a copy to a friend. The friend receives the communication and is given the ability to join using one of the methods noted above. In an ideal embodiment of the invention, the original e-mail communication 27 is retrieved or identifying information about the referring patron 26 is provided by the new patron 26 and matched with the existing patron so that an appropriate reward may be communicated to the referring patron.

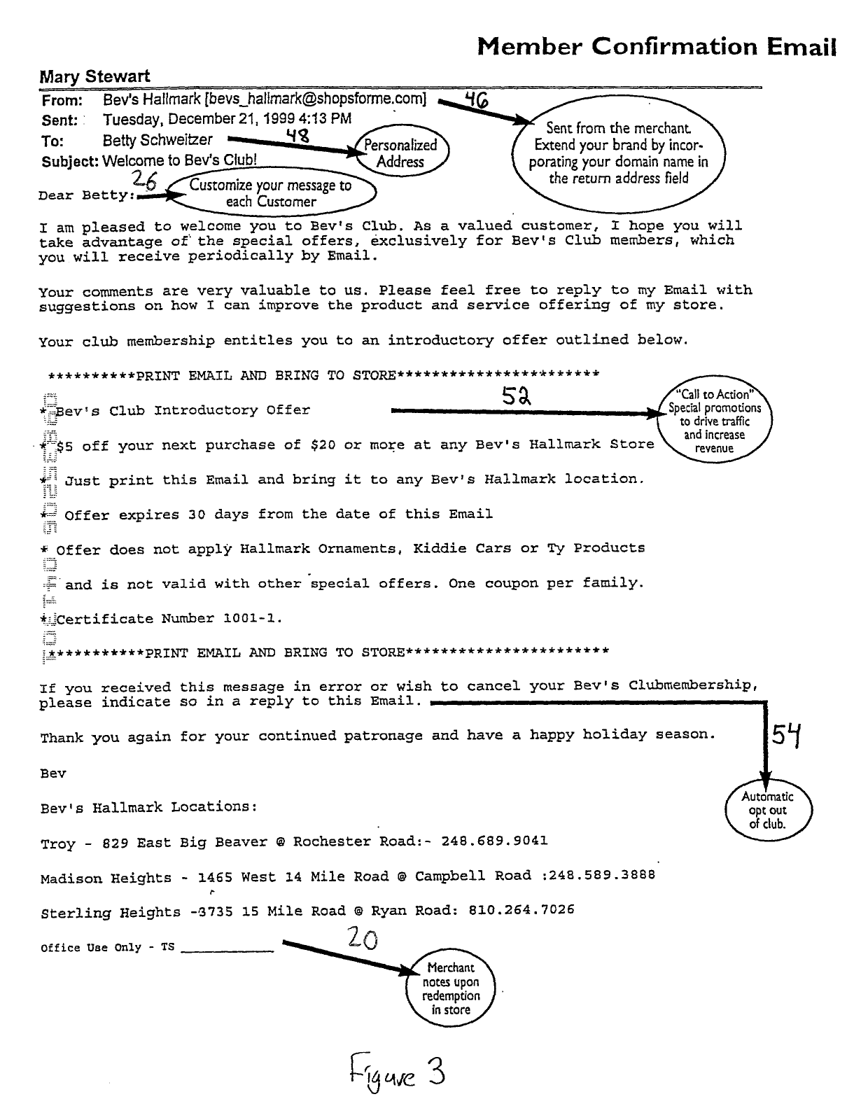

Once the patron 26 has registered with the system 15, the patron often (e.g., within two (2) days) receives an e-mail communication 27 welcoming the patron with a reward in the form of information or a promotional offer, as illustrated in FIG. 3. In other cases, the new patron 26 simply begins to receive all new communications 27 that correspond to the pre-determined criteria that the patron matches. The from field 46 and the to field 48 should be customized and personalized to the extent possible to do so to maximize the chance that the patron 26 will open and read the e-mail instead of deleting it unread. The patron 26 should be personally identified and the “call to action” 52 should be clear and engaging. Each e-mail 27 should also contain an “opt-out” option 54 for the patron 26, to ensure that all member patrons on the system 15 are in fact interested in receiving communications from the merchant 20. The e-mail 27 is typically printed out and taken to the merchant. Redemption information should be recorded by the merchant 20 of the printed e-mail. Alternatively, if an on-line transaction, either the e-mail 27 or identifying information associated with it are communicated to the merchant 20 for forwarding to clearinghouse 24.

One important feature of system 15 is the ability to emphasize the relationship between a local merchant 20 and a local patron 26 while taking advantage of economies of scale or desired information that may be at a broader level of interest to the patron, The invention supports the ability to put a local, and more personalized face to the patron 26 on all communications 27. The “From” field 46 informs the patron recipient of the e-mail that the sender of the e-mail is local, although the “Hallmark” brand is international in scope. This feature is important in the use of more personalized communications 27 to build affinity with patrons. Other indicia of closeness in terms of geography are found in the “Subject” field where the national brand name is not included in the name for the e-mail club and the list of local store locations is provided at the bottom of the communication. The preferred embodiment of the invention will take every opportunity to localize a reference to the vicinity of the patron 26.

The flexibility of a merchant 20 to define and target an e-mail campaign at the local level is a power tool to build affinity with patrons 26. The ability a merchant to define the sender of an electronic communication 27, and to define a merchant's relationship to a patron, is an important part of any embodiment of the invention. E-mail clubs can be formed on behalf of the manufacturer of a product or on behalf of the local retailer selling that same product. Thus, an e-mail club for dog owners could be setup on behalf of a dog food manufacturer, or on behalf of local pet stores.

Nevertheless, while a local presence is desired, it is also desirable to provide information to a patron that he or she will find useful, even if it does not immediately result in a purchase decision. For Hallmark, for example, a hyperlink could be embedded in the message that would point the user to the Hallmark web site for information concerning upcoming holidays or free cards that can be downloaded or emailed. In another example, a hospital acting as a merchant 20 may send a reminder to a patron 26 about an upcoming appointment, but include links in the message to information available from a national drug company or a national organization that relates to the subject matter of the appointment. Alternatively, more general information of a local nature may also be included in electronic communication 27 that relates to additional services or products provided by the merchant 20. In this manner, there can be reinforcement between a national brand or national chain and a local merchant 20 that is associated with that brand or chain.

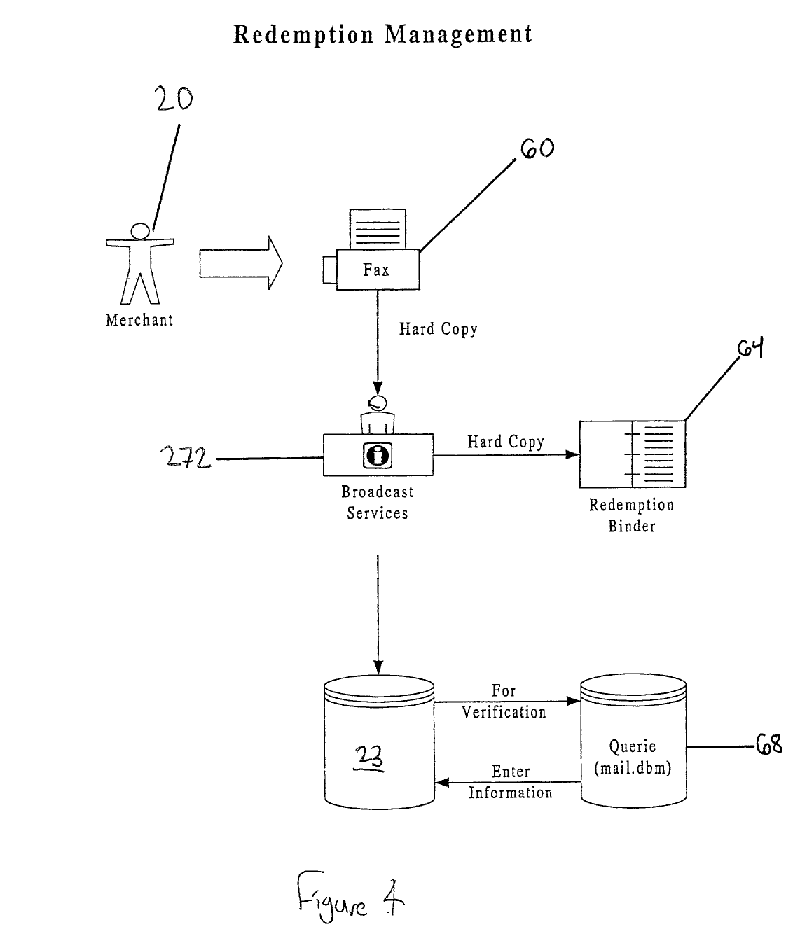

As illustrated in FIG. 4, in one embodiment any redeemed communications are saved by the merchant 20 and forwarded to the clearinghouse 24 using any one of a number of mechanisms (e.g., facsimile) 60. Preferably, the communication received by the patron 26 and given by the patron to the merchant 20 includes least the patron's unique identification code or similar identifying information and a unique communication code (e.g., each communication 27 is given a unique code that is stored in the database). Once received by the clearinghouse 24 it is matched by broadcast services 272 at point 62 with the patron 26 and communication code 66, the match between the two being entered into the database 23 to show that the patron has participated by responding to the communication. The degree of participation may be used to further focus communications to those patrons 26 having the greatest interest in the merchant 20 and thus providing increased rewards based on participation.

A physical copy of the redeemed communication 27 may be kept in a redemption binder 64 for further reference. To avoid manual keying, bar codes or the like may be in the communication that can be read by a special optical character reader.

In another embodiment, if the patron has received an identification device 18 (shown in FIG. 1) including the unique identification number, the identification device may be used in association with the ISU 17 (shown in FIG. 1) to acknowledge redemption. Thus, manual keying of least the patron information with its potential errors is avoided.

The identification device 18 and ISU 17 are important to the system 15 for a variety of reasons. As noted above the identification device 18 is associated with the patron 26 and its database entry through the use of a unique patron identification code. The ISU 17 has the ability to read the device 18 and records the identification code. In its simplest embodiment the ISU 17 simply stores the identification code in a media that may be read from the ISU either through the receipt of physical media (e.g., disk or chip) or through electronic communication (e.g., electronic polling from a phone line). When a patron 26 visits a merchant 20 is in the store and uses to the identification device 18 to communicate with the ISU 17, the system is able to record that the patron is there. Thus, once again the degree of involvement between the patron 26 and merchant 20, even in the absence of an e-mail 27 may be recorded in the database 23 of the clearinghouse 24 for that patron. It provides another avenue for being able measure the level of interest between the patron 26 and the merchant 20. To encourage the use of the identification device 18 by the patron, information or promotional offers may be gauged simply on the number of uses of the ISU 17 associated with a merchant 20 recorded by the system.

In a preferred embodiment, the merchant 20 is able to input information into the ISU 17 directly. Thus, for example, if a patron 26 enters a physical store with a promotional offer in the form of an e-mail communication 27 and redeems the offer, it is possible for the merchant to acknowledge redemption of the offer through the ISU 17 in association with the patron using its identification device 18. A sophisticated input device 18 does not have to be associated with the ISU 17. For example, if there are only a limited number of communications being sent out by a particular patron 26, buttons on the ISU 17 may be associated with each communication 27. If a normal communication is sent out to all patrons only every 90 days and a special communication 27 is only sent out to patrons having a birthday once a year, the redemption of a normal communication 27 may result in pushing a first button and the redemption of a special communication 27 may result in pushing a second button. Then, when the information is received from the ISU 17, the system can correlate the information in the ISU with the communications associated with that merchant and determine from the buttons which communication 27 is associated with each patron's identification device 18 activation.

This does not mean, however, that more sophisticated input systems cannot be associated with a physical ISU 17. For example, in another embodiment of the ISU 17, the merchant can look the communication 27, locate the unique communication code associated with the communication and input that code into the ISU either manually or through the use of an optical reader if the code is able to be deciphered by the reader. In any event, a key advantage of such an embodiment is that no paper copies of the communication have to be maintained that can either be lost or subject to error by potential manual entry into the database 23 at a later date.

In a more preferred embodiment of the ISU, the ISU is directly connected to the merchant sales transaction system 15 and in two-way communication with the clearinghouse 24. Thus, when the patron 26 uses its identification device 18 the patron information may be readily matched to additional information such as the nature of actual purchases, purchase amounts, and the like as well as the information associated with an potential redemption or the like. This is particularly easy when a purchase is made electronically as through a website.

In a most preferred embodiment, not only is the merchant 20 able to input information into the ISU 17, but when a patron 26 uses its identification device 18, the merchant is able to access least portions of the database 23, particularly portions that describe the level of the relationship between the patron and the merchant. In this embodiment, the merchant is able to use the information to provide additional incentives or information as appropriate, and input those additional incentives or information into the ISU 17. The information is forwarded to the database 23.

In yet a further embodiment of the system, the identification device 18 itself may be able to store data such as patron information and merchant preferences. The device 18 may be updated when it interacts with various ISUs 17, so long as the ISU has a database of relevant information and is able to communicated with the identification device.

Various examples of identification devices 18 include a data chip such as a smart chip within a metallic housing, bar codes, finger print identification, voice recognition devices, and the like.

As discussed, there are a number of advantages to using an identification device 18. It provides the availability of instant sign up when a patron 26 goes to a different merchant 20 participating in the system; it allows redemption and marketing opportunities for the merchant and patron. It also permits behavioral tracking to determine how often a patron 26 visits a particular merchant.

In some cases, particularly when there is a separate identification device 18, the providing of a copy of an e-mail communication 27 is not even required. A patron 26 can show up the merchant 20 with its identification device 18, take advantage of the information or promotional offer, show the identification device 18 when checking out, and reference the offer directly.

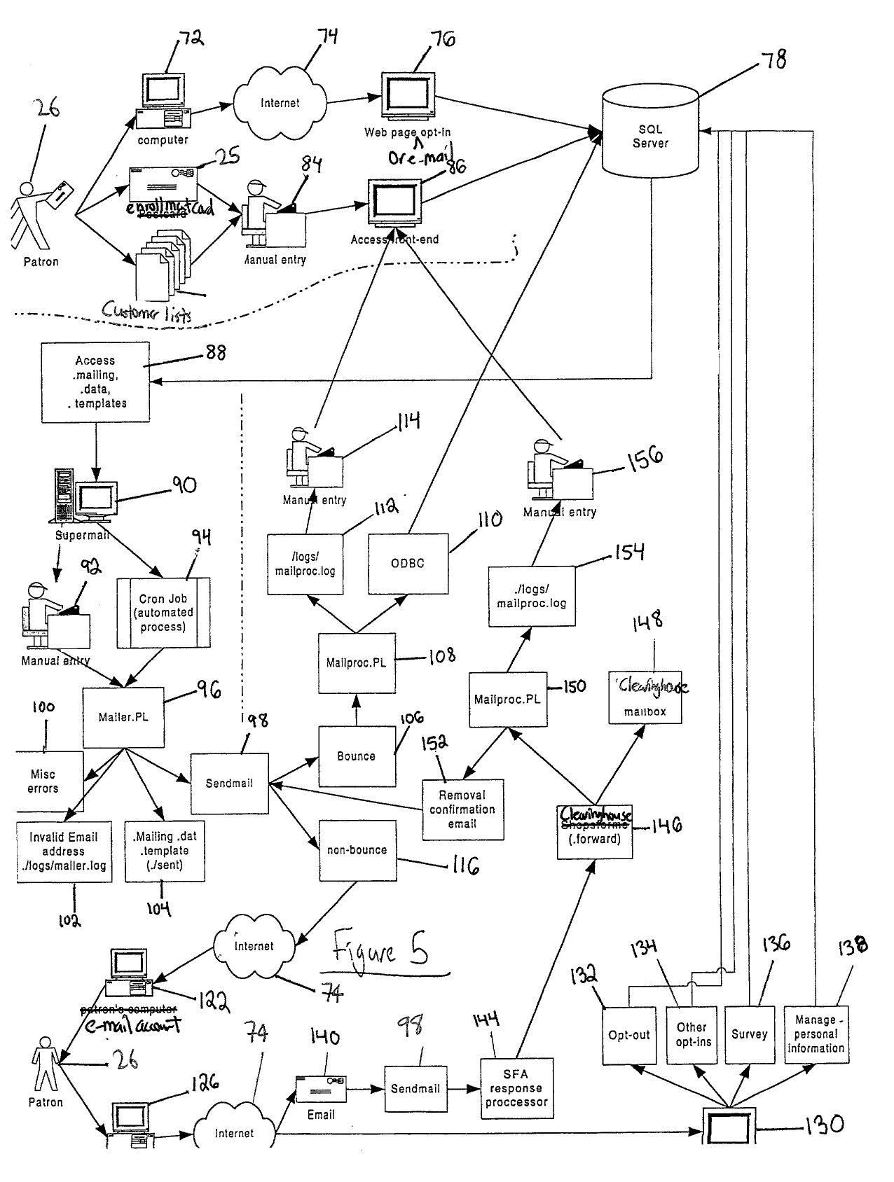

Various processes for associating a patron 26 with a merchant customer list 19 are summarized in FIG. 5. For each process, however, the information is ultimately stored in a master database 23 that may run using a product such as SQL Server from Microsoft Corporation. As also illustrated, a product such as Access, also from Microsoft, may also be used as a front end between manual entry of information concerning a patron 26 and the master database 23.

The master database 23 is a critical component to the system. It includes all of the pertinent information concerning each patron 26 including identifying information, the merchant or merchants 20 associated with that patron, and even the location of each merchant with whom the patron is associated. Moreover, for each patron 26, visits to a particular merchant location are recorded from redemption transactions or the use of the identification device discussed above. Information may be pulled from the database a patron level.

As information about a patron's interest are collected over time, the clearinghouse 24 can make additional offers to a patron 26 concerning other merchants 20 associated with the clearinghouse based on that patron's perceived interest. Surveys and the like may also be used to identify interests of patrons 26. When a survey is used for example, a hyperlink to a survey form associated with a web page that is in direct connection with the master database 23 is most preferred. The information received from the survey is stored directly in the database 23.

Through the collection of such information and promotional offers may be properly directed to a patron 26 without providing the patron information that is not of interest to it. Thus, information and promotional offers are focused to the benefit of both merchants 20 and the patron 26. As noted above, in addition to subject matter interests, if the physical location of the patron is known, as through a zip code, it is possible to also focus patrons on merchants in a specific geographic area.

In addition to being able to retrieve information about a patron 26, the database 23 is able to collate information and retrieve it from a merchant 20 and merchant location level. Thus, it is possible to determine the habits statistically of patrons 26 associated with a particular merchant 20 or merchant location including visits by particular patrons and the success of particular communications sent to patrons, sometimes known as campaigns. In this way, a merchant 20 is able to focus the providing of information and promotional offers in a manner that is of the most benefit for both the patron 26 and the merchant.

In a desired embodiment of the invention not only are there a plurality of patrons 26, but there are also a plurality of merchants 20, each with its own in-store or virtual display 21 (shown in FIG. 1) and preferably an ISU 17. As patrons 26 frequent various participating merchants 20, the patron may acknowledge an interest in receiving information or promotional offers by using the identification device 18 that merchant's location. The unique identification code of the patron is matched with that merchant 20 and merchant location and an entry placed in the database 23 showing the additional merchants that the patron 26 has an interest in. Then surveys and the like, as noted above, can be used to collect any additional information required by that merchant to complete a desired profile. To the extent that information about that patron 26 has already been gathered, a survey using a web site generated form can include that information so that the patron does not have to re-key it and has the opportunity to correct it, if desired.

If a physical identification device 18 is not used, manual, e-mail, or web site opt ins for an additional merchant may also be used. As noted above, the clearinghouse 24 takes information concerning an opt in and compares with existing information already in the database 23. One crucial piece of information compared is the e-mail address. Thus, if there is a match associated with a new entry and an existing database entry based on a match such as an e-mail address, then the system 15 automatically associates both the new merchant information and any additional information associated with that new relationship with the database 23.

Moreover, the clearinghouse 24 receives a significant benefit from the relationship that is created between merchants 20 and patrons 26. By reviewing the data that is created over time between various merchants 20 and patrons 26, the clearinghouse 24 is able to identify trends of benefit to all parties. In this way, proposed offers may be focused to the benefit of all parties to establish relationships that are focused and beneficial.

For example, assume that a number of patrons 26 participating in the system appear to make regular purchases both a card merchant and a florist merchant. If a statistically high enough level of patrons frequent both merchants 20, it may be desirable to propose to the two merchants that they cooperate in a communication focusing on developing additional cross-traffic between the two merchants. Patrons 26 that frequent one merchant may be offered an incentive to visit the other merchant. In another example, taking advantage of geographic proximity and commonality of interests, the clearinghouse 24 can determine that a patron 26 frequents a movie rental merchant on a regular basis. The clearinghouse 24 can propose to a carry out restaurant merchant associated with the system that it provide information or a promotional offer to such a patron as part of a communication suggesting the advantage of having both a movie and a dinner.

It is even possible to establish relationships between merchants 20 at a merchant-to-merchant level. For example, a florist merchant may be in a position to provide services to other merchants that have a need for that merchant's services or products. For example, it may be desirable for a florist merchant to have a flower display at a card store merchant wherein a patron 26 is reminded of the availability of the services of the florist merchant or even potentially has the ability to purchase flowers from the display while the card store merchant. Thus, both merchants 20 again benefit, as does the patron 26.

In short, symbiotic relationships between patrons 26 and merchants 20 may be created using the inventive system 15 of opt in or opt out opportunities so that patrons are not sent undesirable communications and both information and promotional offers may be focused to the benefit of all parties.

An overview of the use of the database to send out a communication according to one embodiment of the invention is detailed in FIG. 5. The patron 26 first must “opt in” to the program associated with a merchant 20. This can be done by an a computer 72 through the Internet 74 using a web page opt-in 76 which directly accesses the database 23. Enrollment can also be accomplished through an enrollment card 25 or a customer list 19, as discussed above. Both methods require manual entry 84 into a database front end 86 that accesses database 23.

The master database 23 includes mailing information, data, and templates developed for a particular communication 27, wherein patron 26 and merchant 20 information populates predetermined fields to customize and personalize a communication.

The various information is merged to create the desired communication 27. It is routed to a supermail server 90 and may be released either manually 92 or through a Cron job or automated process 94. When the communication 27 is actually released at point 96 it is hopefully successfully sent using an e-mail sending protocol such as sendmail 98. However, if it is not sent, then it is routed to one of a number of locations such as a bin of miscellaneous errors 100, or invalid e-mail addresses 102. The non-sent e-mails communications are reviewed to determine the source of the errors and the database is updated if an e-mail address has truly become unavailable or the e-mail is re-queued if the error was merely of a transitory nature

For the e-mail communications 27 that were correctly sent from the system 15, the sending information is recorded in a log file 104 that is preferably merged with the database 23 so that the database knows that the communication was sent and an appropriate notation associated with that communication is stored in the server. Preferably, every communication is given a unique identification code and may be matched up with a patron 26 receiving that communication as well as the merchant 20 and merchant location associated with providing the information or promotional offer.

Even if an e-mail communication successfully leaves the system does not mean that it will reach an intended patron. It can still bounce 106 for a number of reasons such as an inability to deliver. As illustrated in the figure, bounce information is either manually reviewed 114 from a log 112 or used to update the database 78 or preferably, the process may be automated such that an ODBC interface 110 is used to automatically update the database 23.

If the e-mail communication 27 is successfully sent and is a non-bounced e-mail 116, it then goes through the Internet 74 to the patron's e-mail account 122.

Once the patron 26 reviews the communication 27 it can print out the communication and go to a merchant 20 to take advantage of the information or promotional offer. Alternatively, the patron 26 can send a communication 27 back to the clearinghouse 24 responding to the original communication using the patron's computer 126 to either send a responsive e-mail 140 or to access the merchant's Internet web site 130. If a response is e-mailed, a process such as sendmail 98 is used. A clearinghouse response processor 144 is forwarded to a mailbox associated with the affected merchant 20 maintained by clearinghouse 24 as shown at point 146. A copy of such e-mails are kept in the mailbox 148, and all e-mails are processed by the mail process 150. Various options are possible in such a communication. If the patron's e-mail response requires a change to the database, the e-mail is logged at 154, and a data entry person at 156 accesses the database front end 86 to make the appropriate change to the database 23. If the patron's e-mail response includes a request for removal, which request is preferably automatically processed and an acknowledgement 152 sent back to the patron. The database 23 is then updated either manually or automatically. Alternatively, it may be a message to a particular e-mail box, in which case the communication is stored in 148 as noted above for later manual retrieval. Further, the responding e-mail communication 27 may include a response with requested information that is typically manually stored and reviewed for manual entry into the database shown at point 156.

As noted above, e-mail communications 27 often include a hyperlink to a web page 130. As also illustrated in the figure, upon the clicking of an embedded hyperlink a patron is taken to a web page associated with that communication 27. Using such a web page interface a patron 26 has a wide variety of different options including opt-out 132, opt-ins 134, surveys 136, and the ability to manage personal information 138. The various forms are directly linked with the system database to avoid the need to manually re-key necessary data, decreasing cost and the possibility of error.

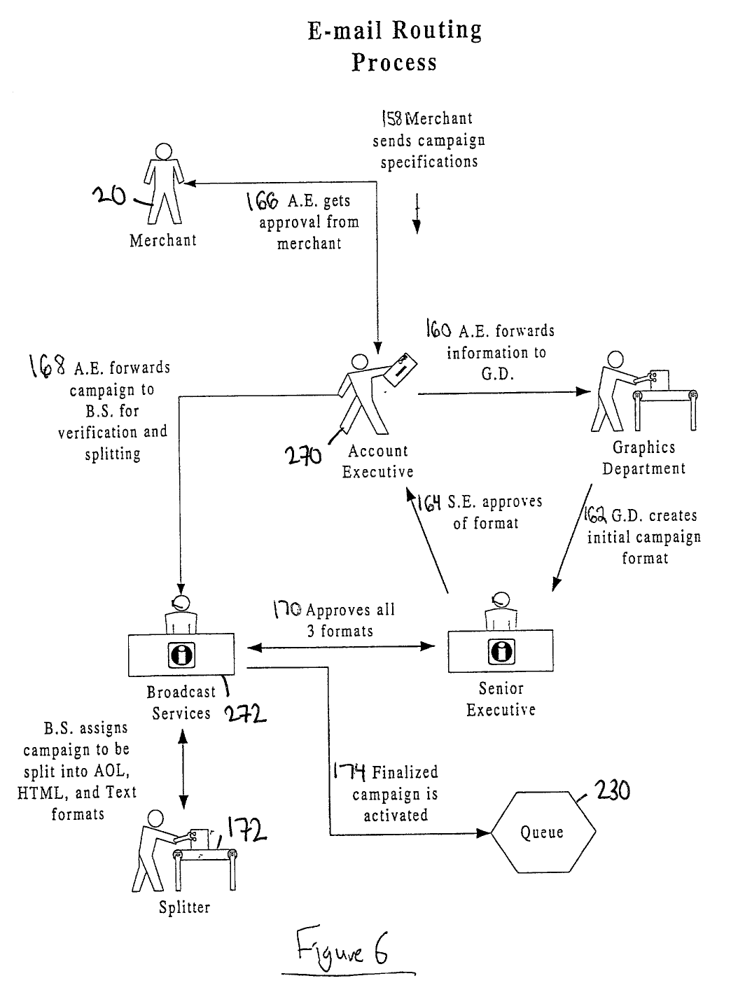

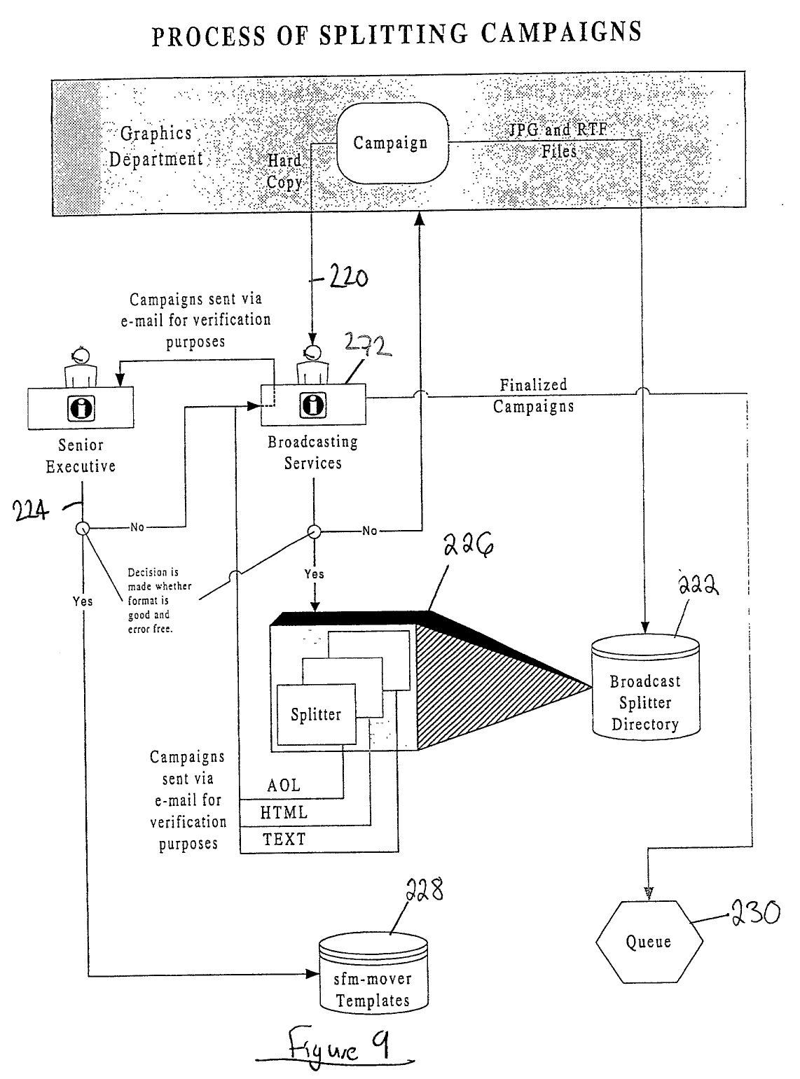

One embodiment of the e-mail routing process is provided in greater detail in FIG. 6. At line 158 a merchant 20 sends campaign specifications to the clearinghouse. The account executive 270 receives and forwards the specifications to the graphics department at line 160. The graphics department creates a proposed campaign format at line 162 that is forwarded to and reviewed by a senior executive of the clearinghouse at line 164 and returned to the account executive if it is approved as shown at line 164. The account executive consults with the merchant 20 and receives the merchant's approval at line 166. Then the process is repeated until it is finalized and the merchant 20 and senior executive both approve of the initial campaign format. The account executive forwards the approved campaign to broadcast services 272 for verification and splitting at line 168. All final formats are created and approved by the senior executive at line 170. Then broadcast services assigns the campaign to be split into various e-mail formats as shown by line 172that are recognized by major e-mail systems such as a format associated with American On Line (“AOL”), HTML, or text. The database 23 preferably includes information associated with each patron 26 to receive a communication 27 that identifies the format of e-mail most preferred by that patron or required by that patron's e-mail system. Finally the campaign is activated and the various communications sent to the e-mail queue 230 (discussed in more detail with respect to FIG. 9) for distribution using line 174.

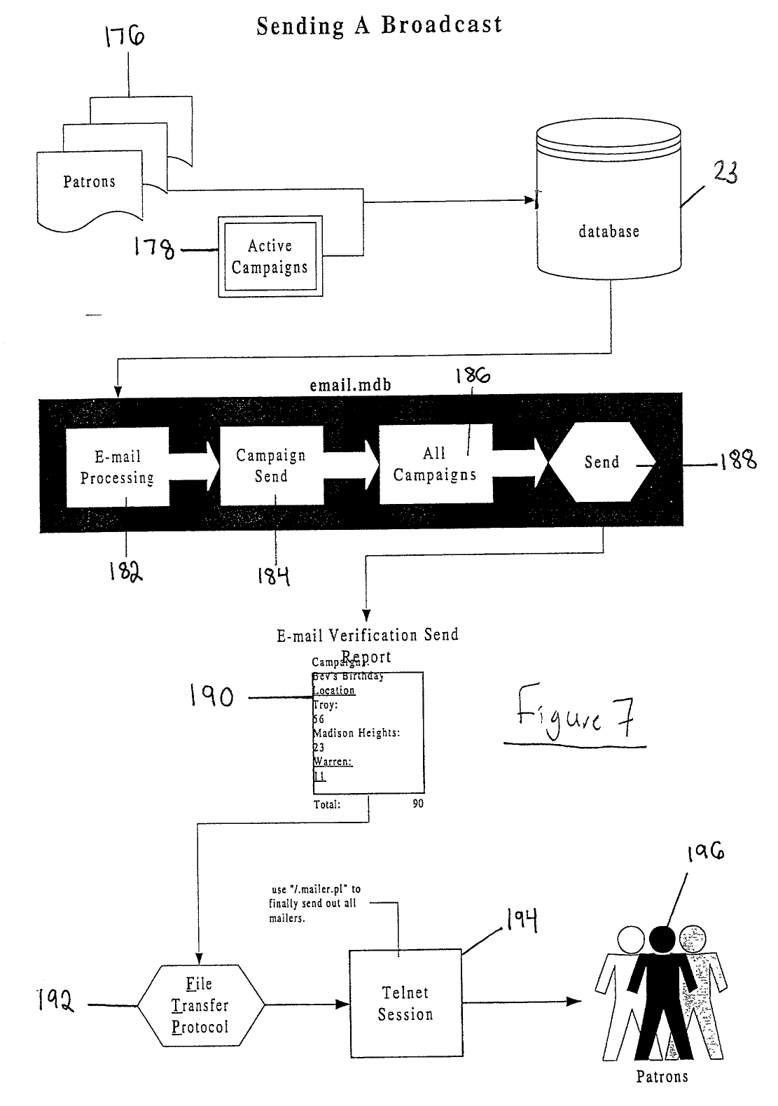

An embodiment of sending the various e-mails is disclosed in greater detail in FIG. 7. As illustrated the database of patrons, 176 which is typically a subset of database 23 is matched with or more active campaigns 178 to involve least a subset of patrons 26 that is stored in the system database 23 of the clearinghouse. A personalized e-mail 27 matching a patron 26 with a communication associated with a campaign is created at point 182 and forwarded to a campaign send queue 184 of an email database. The particular campaign messages is merged with a queue of all campaigns 186 and selectively sent when appropriate as shown by point 188.

Communications 27 are often held until a particular date or time. For example, if a merchant 20 has a large customer list, it may selectively send a communication first to patrons that frequent it more often to give them an earlier chance to take advantage of information or a promotional offer. Then over time the rest of the e-mail communications are sent out to the rest of the merchant's customer list. In another example, a merchant 20 may wish to send a communication to each patron 26 on that patron's birthday. The communications can be queued and sent as the birthday of that patron comes up.

Once the e-mail for a particular merchant communication is completely created and ready to be sent out, an e-mail verification send report 190 is preferably generated. Such a report typically includes the communication identification code, merchant name, merchant locations involved, and the total number of e-mail communications to be sent out. Then the various communications are transmitted to the e-mail server in a manner well known in the art such as by using File Transfer Protocol 192 and a session is created 194 to send out the communications to the preselected subset of patrons 176. In the illustrated embodiment, a telnet session is created to send out the communications.

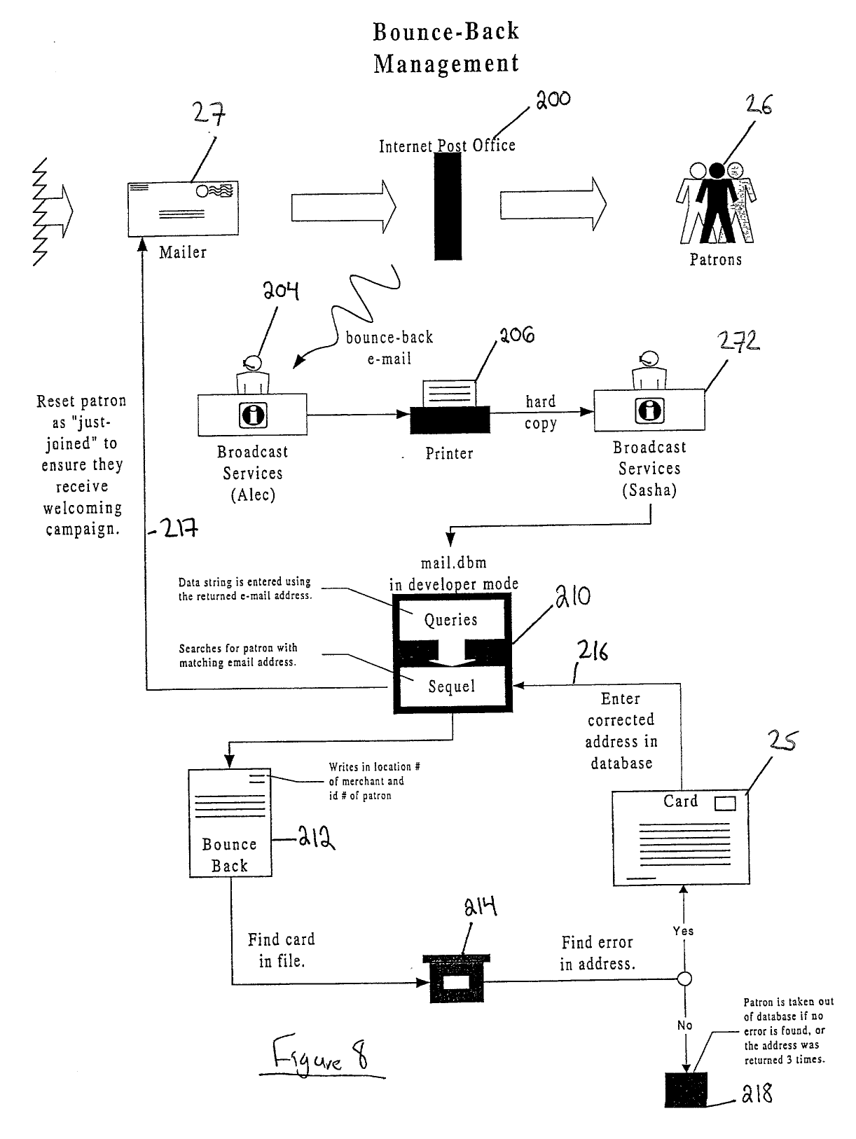

One method of bounce back management is illustrated in FIG. 8. The particular management approach involves the sending of a verification message 27 to a patron 26 once the patron has signed up with the system using a postcard as discussed above. As shown, when operating properly an e-mail communication 27 should travel through the Internet through one or more internet post offices 200 to reach the appropriate patron 26. However, when an e-mail communication 27 is bounced it is reviewed by broadcast services 272 at point 204 and printed out for review 206. The communication is reviewed to determine the reason for the error 208. A mail portion 210 of the master database 23 is reviewed to locate the patron's record of information and the record is reviewed. If the error involves an improper e-mail address it is typical to determine the merchant 20 and merchant location at point 212 from the communication and to go to a file 214 where all of the enrollment card 25 associated with that merchant location are stored as shown in FIG. 2 to determine if the address was mis-keyed. If it was then the correct address is entered into the database 23 as shown by line 216 and the e-mail communication is resent as shown by line 217. Otherwise, the patron 26 is removed from the database 23 or marked inactive at point 218 if various attempts to resend the e-mail communication fail. In the embodiment at 218, the patron is removed from the database 23 after three separate attempts to send the e-mail communication 27.

An embodiment of splitting a communication into various e-mail formats is illustrated in FIG. 9. Once the graphics department has finalized a campaign a hard copy of the communication template is sent to broadcast services as shown by line 220. The electronic form of the communication including JPEG image files and Rich Text Format text based files are stored in a readily accessible directory and may comprise part of a database 222. An executive of the clearinghouse 24 works with broadcast services to decide whether the format proposed by the graphics department is good and error free for each of the various e-mail formats to be used as shown by line 224. If not, then the campaign is returned to the broadcasting services department 272 for reworking. Once the campaign is believed finalized and approved, it may be desirable to send test messages 226 using each format to confirm their accuracy and then complete finalization of the campaign. The senior executive is responsible for making an entry involving the sfm-mover templates as shown by line 228. Broadcast services in combination with the executive actually split the campaign into typical formats recognized by most e-mail systems including American On Line (“AOL”), HTML, and text. The formats are merged with the actual image and text files and stored for release to a queue 230 to be merged with the appropriate sub-set of patrons. As stated above, the database 23 preferably includes information about the e-mail format desired by a patron 26. Alternatively, it may be possible to send all three formats in a single e-mail communication with only one format being reviewed by the patron 26 based on the desired format used by the patron. Further, it is sometimes possible to send query messages to a patron e-mail address to determine the desired format for the communication before the communication is actually transmitted in full.

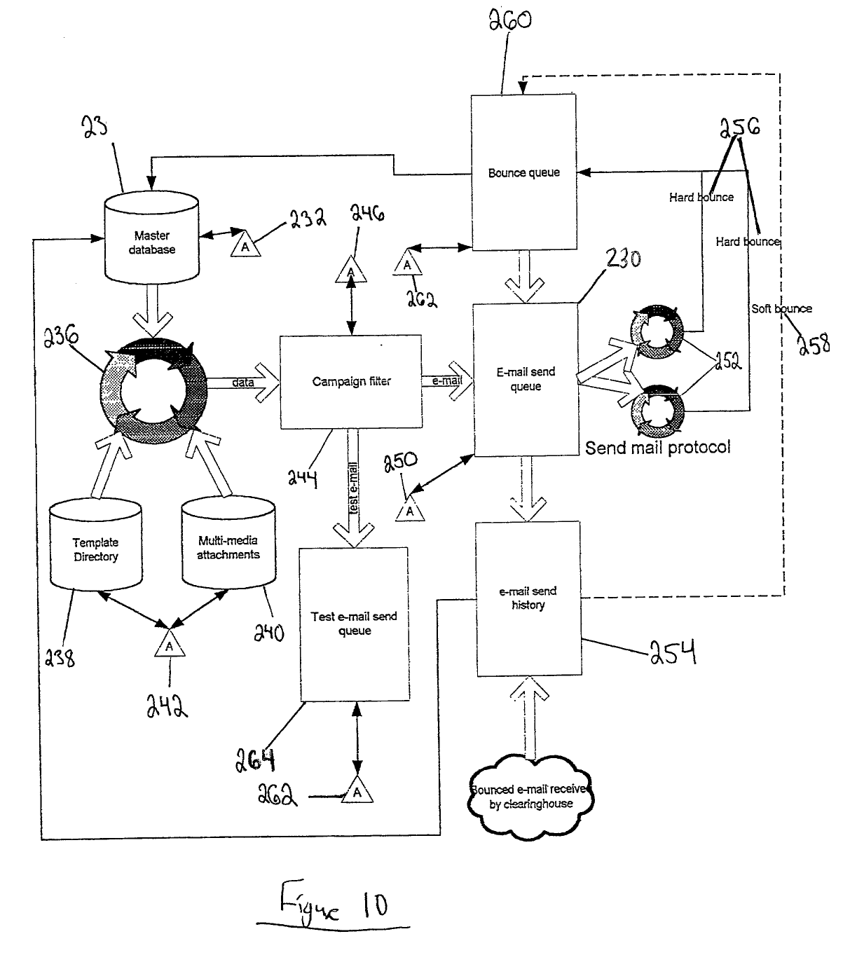

An alternative embodiment for sending out communications is illustrated in FIG. 10. In the figure the A in the triangle 232, 242, 246, 250, and 262 represents program interfaces to the e-mail system. The main database 23 with patron information that may be updated or changed is shown in ready contact 236 with templates associated with a campaign 238 and any associated images and other multi-media attachments 240. The templates and multi-media may be modified using a variety of applications. The templates, multi-media content and database information go through a campaign filter 244 to match a campaign with a subset of patrons 26 to be associated with that campaign. The campaign filter is essentially the rule generator that combines the database information with a campaign. Once leaving the campaign filter a completed series of customized e-mail communications exist. E-mail messages 27 may first be sent to a test e-mail queue 264 so that the formatting and substance of the e-mail may first be verified. The e-mail communications go from the campaign filter 244 to an e-mail send queue 230 where they are stored, as discussed above. In addition to a preferred campaign identification code it is preferred that each batch of e-mail communications also be assigned a unique batch number. By way of the batch number it is easy to delete or otherwise modify a batch if an error is located before the batch is completely released. The e-mail queue 230 stores the messages until a release time is matched with the communication. As noted above, such release times may be based on a desire to favor frequent patrons or a special event in a patron's life such as a birthday, anniversary, or any other special day noted in a patron profile. Thus a prioritized queue is possible. The queue 230 is associated with the database 23. In a preferred embodiment a query on a patron 26 or a merchant 20 or merchant location will provide information on the status of all relevant queued e-mail communications.

As also illustrated in the Figure the e-mail send queue is a scalable function with a multiple number of e-mail send protocols 252 being available to be used simultaneously depending on the number of queued communications that are ready to be sent.

When an e-mail is correctly sent out then its transmission is recorded in a long-term history table 254 that is associated with the main database 23. Once again the history table may be queried in association with a patron 26, merchant 20 or merchant location or in a variety of other ways such as the number of messages sent out over a particular period of time and the like to provide updated information. Thus, the history table 234 ideally includes the patron identification code, the merchant identification code and related merchant information, the campaign identification code, batch code, and information concerning e-mail communication release date and time. Moreover, using the history table information one or more automatic e-mail communications can be generated to a merchant 20 associated with a campaign informing the merchant that a campaign has been launched and the status of the campaign various times.

Additional, e-mail communications can be sent to a merchant 20 on a variety of other topics including providing notification that a campaign has passed the campaign filter and the status of release when it resides within the e-mail send queue.

Two different types of e-mail communication bouncing are illustrated in the Figure. A hard bounce 256 is generated by the e-mail send protocol itself and involves when the engine cannot get to the domain where the e-mail address is located or the like. A hard bounce goes to a bounce queue 260. A soft bounce 258 is a rejection to an e-mail communication 27 that often arrives days after an e-mail communication is sent out. It often involves a notification of an inability to complete the delivery process to a particular e-mail address even though the domain itself is up and accessible. In the case of a soft bounce 258, the e-mail communication 27 is preferably automatically mated with a corresponding communication stored in the history table 254 and the status updated to reflect a soft bounce. The original e-mail communication is pulled from the history table information and forwarded to the bounce queue 260. An interaction with the bounce queue may be automatic or manual in a manner similar to that discussed above with a different embodiment involving bounced e-mail communications. If the e-mail address problem can be fixed then the e-mail communication is re-queued, often on a priority basis and resent out.

Using the campaign feature of the system 15, information can even be sent out daily or more to select patrons 26. For example, a high volume shop such as a restaurant may send out a daily menu of specials to select patrons. That alone provides important information to the patron 26. However, in a preferred embodiment a hyperlink is provided that the patron clicks on to receive additional merchant information and even potentially the ability to pre-order a meal for later pickup or automatic deliver. This helps the merchant 20 plan ahead and the patron in avoiding unwanted delays.

While the term database 23 has been used fairly generically throughout the discussion, in practice it is likely that the system will include a variety of different databases. For example, there may be a patron database, a merchant specific database, campaign databases, and various e-mail databases. However, the various databases are interconnected using identification codes common to the various databases such as patron identification codes, merchant and merchant location codes, communication or campaign codes, mail batch codes, and the like as noted above. Thus, the various databases can be searched and combined to provide an overall comprehensive database of information.

In one embodiment a first table includes merchant specific information, a second table includes location specific information for a specific merchant, a third table is really a hash table containing the location information for a merchant and a unique patron number and showing the points of interaction between the two parties. Finally, a fourth table typically provides all relevant information about a particular patron. The patron table may be linked to certain adhoc tables associated with a merchant if the merchant wants very specialized information about a patron that is not likely to be of interest to other merchants.

The preceding discussion has included substantial reference to a unique identification code for a patron. In practice, the identification code is randomized and encrypted for use with e-mail communications and/or the identification device so that third parties are not able to use the identification code in an inappropriate manner. The system takes substantial steps to protect the integrity and confidentiality of both patron and merchant information. For example the system database is behind an appropriate firewall using methodology well known to those of appropriate skill in the art. Another advantage of using an e-mail queue, for example, is that the completed e-mails can be isolated from the underlying database.

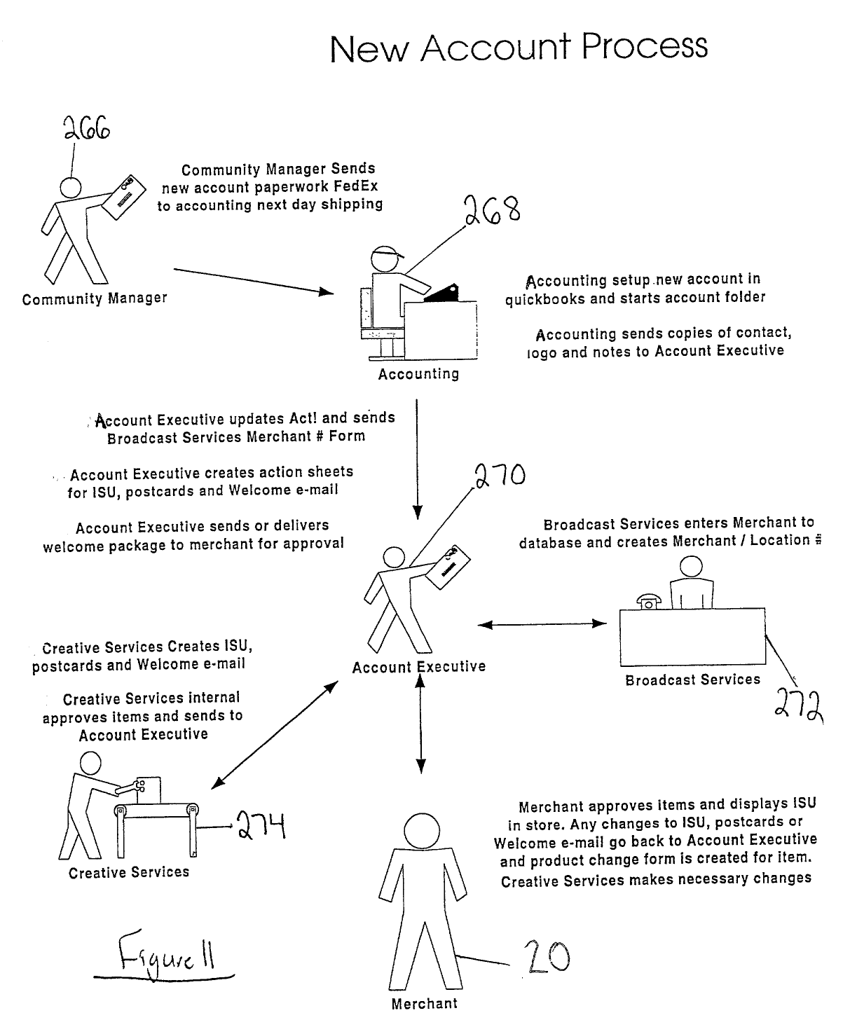

The establishment of a business relationship between the merchant and the clearinghouse is summarized in FIG. 11. First, a community manager 266 associated with the clearinghouse 24 establishes a relationship with the merchant 20. The community manager sends new account information about the merchant 20 to the information clearinghouse 24. Typical information associated with a merchant includes its SIC code, if it is part of a chain, its geographic location, and specific patron 26 information of specialized interest desired by the merchant. In many situations the merchant 20 may be part of a chain so both a merchant identification code and a location code are established. The accounting department 268 of the information clearinghouse 24 sets up an account associated with the merchant and with each merchant location. The accounting department 268 of the information clearinghouse then sends copies of the contact, logo, and notes to the account executive 270.

The account executive 270 updates the account information and sends the broadcast services department 272 the new account information relating to the merchant. The broadcast services department 272 enters all merchant related information on the information clearinghouse's database 23 for merchant information. The account executive 274 creates action sheets for ISU 17, postcards 25, customer lists 19, and a draft welcome e-mail 27, and the account executive sends the action sheets to the creative services department 274 which then creates the ISU, postcards, and welcome e-mail. Personnel internal to the client services department 274 approve the ISU 17, postcards 25, customer list 19, and proposed welcome e-mail 27, and send all the items to the account executive 270. The account executive 270 sends the proposed welcome package to the merchant 20, including patron contact information, action sheets for use with an ISU, postcards, and a proposed welcome e-mail 27 to be sent using the existing customer list 19 of the merchant 20 to the extent an e-mail address is associated with a particular patron. The merchant receives and approves of the welcome package and displays the ISU 17 in the store or on its website. Any changes to the ISU 17, postcards 25 or welcome e-mail 27 go back to the Account Executive 270 who fills out a product change form that is used by creative services to make any necessary changes.

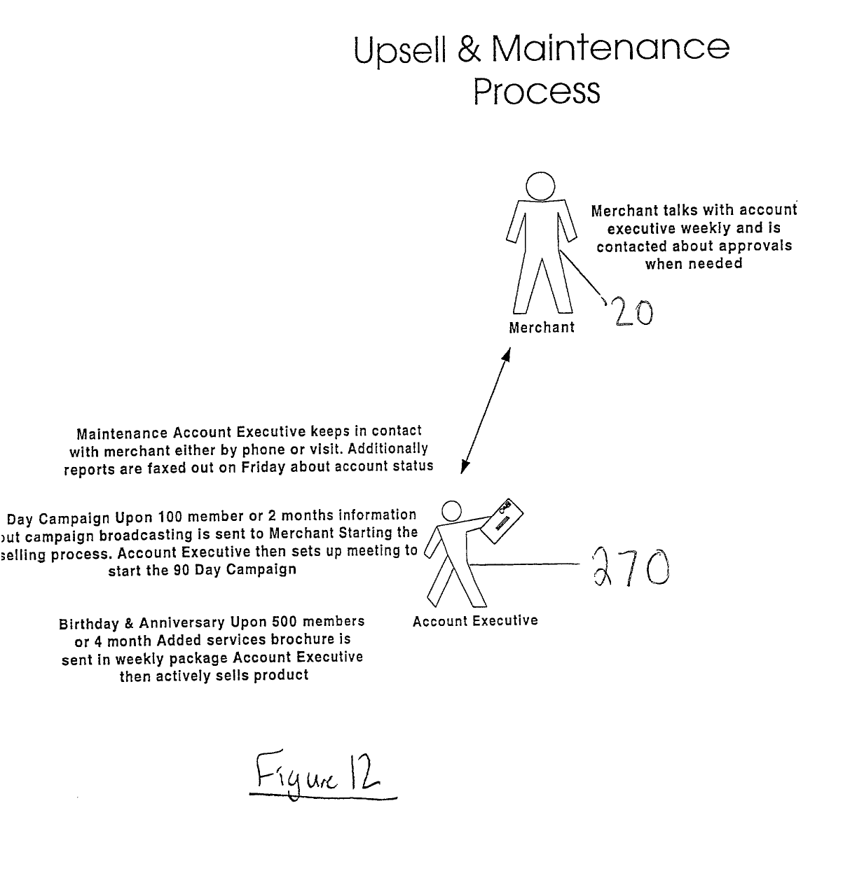

The maintenance of the relationship between the information clearinghouse 24 and the merchant 20 is illustrated in FIG. 12. The merchant 20 and the account executive 270 communicate on a regular, preferably weekly basis. The communication typically comprises phone calls, faxes, visits, or e-mail and includes regular reports associated with account status. As part of the relationship and regular communication the information clearinghouse 24 and the merchant 20 develop communications 27 to share with the patrons 26. For example, one communication 27 that may be created includes a 90-day promotional redemption program that is implemented once the customer list includes a critical number of patrons (e.g., 100 patrons) or the relationship has been established for a predetermined time period (e.g., 2 months). Another communication 27 that may be created includes a personalized message to patrons 26 upon the occurrence of a personal event of importance to the patron such as a birthday, anniversary, or any other special occasion identified in a patron profile. Such a communication 27 may be created upon the establishment of a customer list having a different critical mass of patrons (e.g., 500) or the relationship has been established for a predetermined time period (e.g., 4 months).

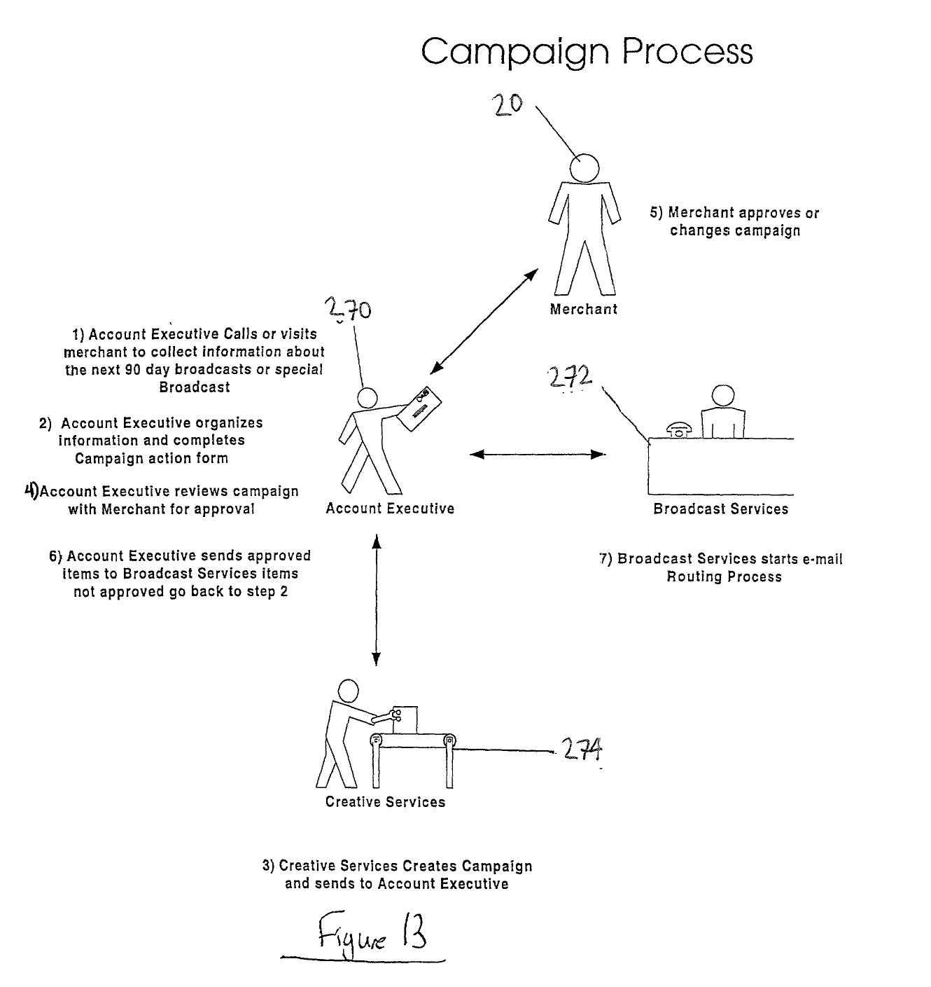

The creation of a personalized communication 27 to least a subset of the merchant's customer list is carried out as illustrated in FIG. 13. First, the account executive 270 and the merchant 20 meet and develop a communication 27 that will be available for use or redemption for a predetermined period of time (e.g., 90 days), or a special communication that may focus, for example, on an important event in a patron's life. Creative services 274 works with the account executive 270. The account executive 270 organizes the information and completes a communication action form or “campaign action form.” The campaign action form is reviewed with the merchant 20 for approval. Once the campaign is approved, broadcast services 272 implements the communication process and sends the communication to the appropriate patrons 26 associated with the merchant 20.

In some cases the process may be simplified by permitting the merchant 20 to itself create the relevant information associated with a desired campaign such as the welcome package. The clearinghouse 24 reviews the merchant provided information simply for formality compliance and then proceeds as if approval has been granted. In one desired embodiment, a merchant 20 is given access to a Uniform Resource Locator (“URL”) of a website, where Active Server Pages (“ASP”) or the like are used to provide pre-formatted templates that a merchant 20 completes, which is then used by the clearinghouse to activate the campaign.

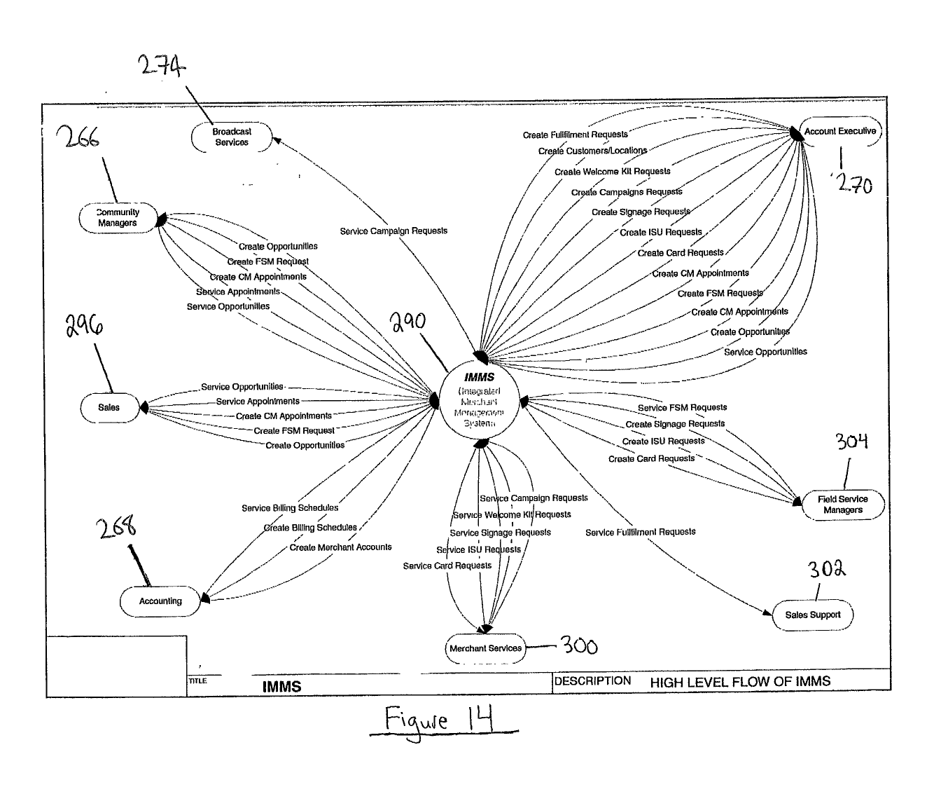

The present invention contemplates an information clearinghouse with a merchant-driven focus. In a preferred embodiment, the information clearinghouse 24 will be organized in such a way as to maximize responsiveness to the needs of merchants 20 in an integrated and comprehensive manner. The structure for such a system is referred to as IMMS, or Integrated Merchant Management System. IMMS is illustrated on FIG. 14. IMMS 290 represents all of the various departments and internal workings of the information clearinghouse. The figure illustrates the responsibilities of broadcast services 274, community managers 294, sales 296, accounting 298, merchant services 300, sales support 302, field service managers 304, and account executive 270.

In accordance with the provision of the patent statutes, the principles and modes of operation of this invention have been explained and illustrated in preferred embodiments. However, it must be understood that this invention may be practiced otherwise than as specifically explained and illustrated without departing from its spirit or scope.

What is claimed is:

1. An information and redemption system comprising:
a merchant;
a plurality of participating patrons; and
a clearinghouse;
wherein each participating patron has supplied an e-mail address for use by said clearinghouse;
wherein said clearinghouse provides electronic communications including information or promotional offers about said merchant to a subset of said participating patrons; and
wherein said electronic communications can be redeemed or responded to by said participating patrons.

2. An information and redemption system as recited in claim 1, wherein a unique patron identification code is associated with each of said participating patrons and a unique merchant code is associated with each said merchant.

3. An information and redemption system as recited in claim 1, wherein said clearinghouse facilitates the exchange of patron information between different merchants.

4. An information and redemption system as recited in claim 1, wherein said electronic communication sent to said subset of said participating patrons by said clearinghouse contains content and personalization based on the participating patron's profile information.

5. An information and redemption system as recited in claim 1, wherein said participating patrons are given offers exclusive to said participating patrons.

6. An information and redemption system as recited in claim 1, wherein there are a plurality of merchants, and said clearinghouse matches a subset of said merchants with a subset of said participating patrons based on the likelihood of mutual merchant and patron interest.

7. An information and redemption system as recited in claim 1, wherein a participating patron is entered into a database associated with said clearinghouse upon receipt of an e-mail address by said clearinghouse, and said e-mail address being verified through the sending of a test electronic communication to said participating patron and the success of said test electronic communication being confirmed within said database.

8. An information and redemption system as recited in claim 1, wherein least one of said electronic communications includes a hyperlink such that when a participating patron clicks on said hyperlink, the patron is directed to a web site page associated with said hyperlink.

9. An information and redemption system as recited in claim 1, wherein said clearinghouse matches said participating patrons with a communication to prepare a personalized communication for each said subset of said participating patrons, said personalized communication being sent by electronic mail to said participating patrons.

10. An information and redemption system as recited in claim 1, wherein said system generates tracking reports to monitor at least one of the number of said participating patrons, new enrollments, participant patron comments, new enrollment referrals, new patron profiles, and the general effectiveness of a particular electronic communication.

11. An information and redemption system as recited in claim 1, wherein said electronic communications are part of an ongoing two-way process between said participating patrons and said merchant.

12. An information redemption system as recited in claim 1, wherein said electronic communications are sent out based on at least two of the following criteria: a periodic basis, as the result of special events, or as a result of information contained in said patron profile of said participating patron.

13. An information and redemption system as recited in claim 2, wherein said merchant has a plurality of locations, each location is given a location identification code unique for that merchant.

14. An information and redemption system as recited in claim 2, wherein a participating patron is given an identification device including a form of said unique patron identification code and said merchant has a unit that is able to communicate with said identification device and store information regarding a visit by the patron to said merchant when said participating patron activates said unit with said identification device.

15. An information and redemption system as recited in claim 14, wherein a participating patron is given an identification device including a form of said unique patron identification code and said identification code may be used with multiple merchants affiliated with said clearinghouse.

16. An information and redemption system as recited in claim 14, wherein said unit includes a merchant interface such that said merchant may enter information relating to a transaction involving said participating patron.

17. An information and redemption system as recited in claim 16 wherein said unit is a physical unit with a plurality of buttons, least one of said buttons reflecting a redemption offer, said button being activated in association with said identification device to associate said patron with said redemption offer.

18. An information and redemption system as recited in claim 14, wherein data in said unit is communicated to said clearinghouse on a periodic basis using one of a manual transfer of information and a direct electronic connection.

19. An information and redemption system comprising:
a merchant, a unique merchant code associated with said merchant;
a plurality of patrons, a unique patron code associated with each of said patrons; and
a clearinghouse;
wherein each patron participating in the system has supplied an e-mail address to either said merchant or said clearinghouse;
wherein said clearinghouse provides e-mail communications including information or promotional offers about said merchant to a subset of said patrons, said clearinghouse utilizing a profile associated with said patrons to create said subset;
wherein said e-mail communications can be redeemed by said patrons or said patrons can respond by sending a new e-mail communication to either said merchant or said clearinghouse; and
wherein said merchant has a unit that is able to communicate with said identification device and store information regarding a visit by said patron to said merchant when said patron activates said unit with said identification device.

20. An information and redemption system as recited in claim 19, wherein there are a plurality of merchants, said clearinghouse matching a subset of said merchants with said participating patrons based upon mutual merchant and patron interest.

21. An information and redemption system as recited in claim 19, wherein least one of said communications includes a hyperlink such that when a patron clicks on said hyperlink, it is directed to a web site page associated with said hyperlink.

22. An information and redemption system as recited in claim 19, wherein said communications are sent out on a periodic basis, as the result of special events, or as a result of information contained in said patron profile of said participating patron.

23. An information and redemption system as recited in claim 19, wherein a participating patron is given an identification device including a form of said unique patron identification code and said identification code may be used with multiple merchants affiliated with said clearinghouse.

24. An information and redemption system as recited in claim 19, wherein said system generates tracking reports to monitor the number of said participating patrons, the number of new participating patrons, patron comments, referrals from participating patrons, patron profiles, and the general success of said merchant's use of said system.

25. A method for developing an affinity relationship between a merchant and participating patrons comprising of:
electronically maintaining a profile for each participating patron that each said participating patron can read and modify;
maintaining a database tracking patron behavior and communication with respect to said merchant;
sending targeted and personalized electronic communications to a subset of said participating patrons based on said patron profile; and
allowing each recipient of said electronic communication to redeem said electronic communications or send a reply to said merchant.

26. A method as recited in claim 25, wherein a unique patron identification code is used to identify said patron in said database.

27. A method as recited in claim 25, wherein a unique merchant identification code is used to identify said merchant in said database.

28. A method as recited in claim 27, wherein a merchant location number unique to that merchant is used to identify each location of said merchant in said database if said merchant has more than one location.

29. A method as recited in claim 25, wherein said merchant can exchange information relating to their patrons with other said merchants through the use of a clearinghouse.
